(19) United States
(12) Patent Application Publication
(10) Pub. No.: US 2010/0026259 A1
(43) Pub. Date: Feb. 4, 2010

(54) DC-DC CONVERTER INTEGRATED CIRCUIT AND DC-DC CONVERTER

(75) Inventors: Kaoru Ozaki, Kanagawa-ken (JP); Yuichi Goto, Kanagawa-ken (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/509,573

(22) Filed: Jul. 27, 2009

(30) Foreign Application Priority Data
Jul. 30, 2008 (JP) 2008-196567

(51) Int. Cl. G05F 1/10

(52) U.S. Cl. 323/282

(57) ABSTRACT

A DC-DC converter integrated circuit includes: a switching terminal; a feedback terminal; a high-side transistor operable to output a voltage through the switching terminal in ON state; a voltage sensor operable to compare voltage at the switching terminal with a first reference voltage; an error amplifier operable to generate an error signal from voltage at the feedback terminal and a second reference voltage; and a control circuit on detecting the voltage at the switching terminal higher than the first reference voltage in OFF state of the high-side transistor using the voltage sensor, operable to make the high-side transistor turn off in a next period after detecting the voltage at the feedback terminal higher than the second reference voltage using the error signal, and turn on in a next period after detecting the voltage at the feedback terminal lower than the second reference voltage using the error signal.

### CROSS-REFERENCE TO RELATED APPLICATIONS

This application is based upon and claims the benefit of priority from the prior Japanese Patent Application No. 2008-196567, filed on Jul. 30, 2008; the entire contents of which are incorporated herein by reference.

### BACKGROUND OF THE INVENTION

1. Field of the Invention

This invention relates to a DC-DC converter integrated circuit and a DC-DC converter.

2. Background Art

It is necessary for downsizing and performance enhancement of electronic devices such as notebook personal computers and cellular phones to provide small DC-DC converters and switching regulators having high power conversion efficiency.

A step-down DC-DC converter can output a constant voltage by turning on/off a MOSFET switch and smoothing the output voltage using an LC filter. Here, a CMOS integrated circuit including an oscillation circuit, a control logic, a driver, and a MOSFET facilitates downsizing the DC-DC converter and reducing its power consumption.

A DC-DC converter needs to maintain high power conversion efficiency over a wide range of load current. However, despite high efficiency at rated load, the efficiency may decrease at light load.

JP-A-2000-092824 (Kokai) discloses a technique related to a switching regulator realizing high power conversion efficiency for a wide range of load current. In this technique, if a second switch is in the ON state and potential at an output node exceeds a prescribed potential, then the second switch is turned to the OFF state, thereby improving power conversion efficiency for low load current.

However, even this technique may cause a problem of increased output voltage in an operation of a light-load discontinuous control mode.

### SUMMARY OF THE INVENTION

According to an aspect of the invention, there is provided a DC-DC converter integrated circuit comprising: a switching terminal; a feedback terminal; a high-side transistor operable to output a voltage through the switching terminal in ON state; a voltage sensor operable to compare voltage at the switching terminal with a first reference voltage; an error amplifier operable to generate an error signal from voltage at the feedback terminal and a second reference voltage; and a control circuit on detecting the voltage at the switching terminal higher than the first reference voltage in OFF state of the high-side transistor using the voltage sensor, operable to make the high-side transistor turn off in a next period after detecting the voltage at the feedback terminal higher than the second reference voltage using the error signal, and turn on in a next period after detecting the voltage at the feedback terminal lower than the second reference voltage using the error signal.

According to other aspect of the invention, there is provided a DC-DC converter comprising: a DC-DC converter integrated circuit including: a switching terminal;

a feedback terminal; a high-side transistor operable to output a voltage through the switching terminal in ON state; and a control circuit in a case of the voltage at the switching terminal higher than a first reference voltage in OFF state of the high-side transistor, operable to make the high-side transistor turn off in a next period after detecting the voltage at the feedback terminal higher than a second reference voltage, and turn on in a next period after detecting the voltage at the feedback terminal lower than the second reference voltage; an output terminal; an inductor interposed between the switching terminal and the output terminal; a diode interposed between the switching terminal and ground; and voltage sense resistors interposed between the output terminal and the ground and connected in series so as to allow voltage at the connection node therebetween to be fed back to the feedback terminal.

According to other aspect of the invention, there is provided a DC-DC converter comprising: a DC-DC converter integrated circuit including: a switching terminal;

a feedback terminal; a low-side switch control terminal; a high-side transistor operable to output a voltage through the switching terminal in ON state; and a control circuit on detecting the voltage at the switching terminal lower than the first reference voltage in the OFF state of the high-side transistor, operable to make the high-side transistor turn on every period and output a control signal to the low-side switch control terminal; an output terminal; a low-side transistor connected between the switching terminal and ground and allowed to be turned on or off complementarily to the high-side transistor by the control signal from the low-side switch control terminal; an inductor interposed between the switching terminal and the output terminal; and voltage sense resistors interposed between the output terminal and the ground and connected in series so as to allow voltage at the connection node therebetween to be fed back to the feedback terminal.

### BRIEF DESCRIPTION OF THE DRAWINGS

FIG. 1 is a block diagram of a DC-DC converter according to a first embodiment;

FIGS. 2A and 2B are operating waveform charts of the DC-DC converter according to the first embodiment;

FIGS. 3A and 3B show a block diagram of a DC-DC converter according to a comparative example and an operating waveform chart in a light-load state; and

FIGS. 4A and 4B show a block diagram of a DC-DC converter according to a second embodiment.

### DETAILED DESCRIPTION OF THE INVENTION

Embodiments of the invention will now be described with reference to the drawings.

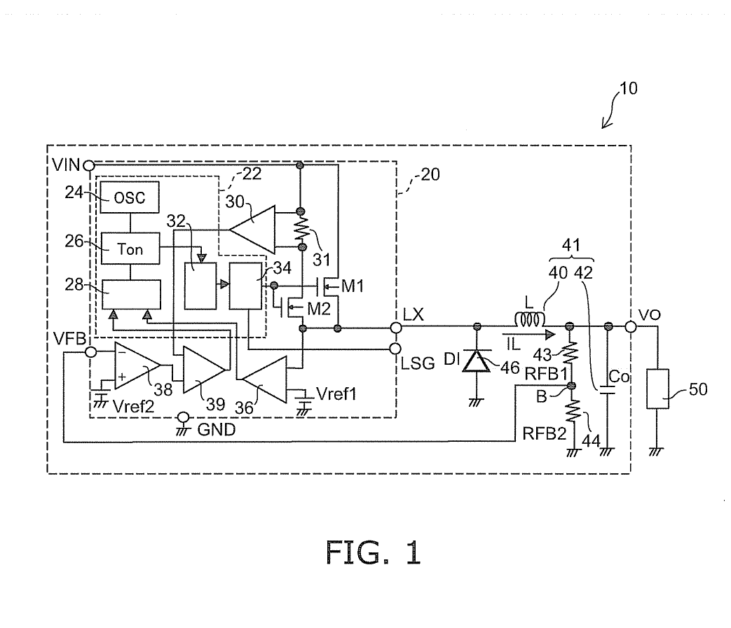

FIG. 1 is a block diagram of a DC-DC converter according to a first embodiment of the invention.

The DC-DC converter 10 includes an integrated circuit (IC) chip 20, an inductor 40, an output capacitor 42, voltage sense resistors 43, 44, and a diode (DI) 46. A load 50 is connected between an output voltage (VO) terminal of the DC-DC converter 10 and ground (GND).

The IC chip 20 is illustratively a CMOS integrated circuit, including a high-side transistor M1 (hereinafter referred to as transistor M1) such as an N-channel MOSFET, a control circuit 22, a voltage sensor 36 for a switching terminal (LX terminal), an error amplifier 38, and a comparator 39. Here, the high-side transistor M1 is not limited to a MOSFET, but may be a junction FET.

The control circuit 22 illustratively includes a driver 34 for driving the transistor M1, an oscillator 24 for generating a clock signal, an ON signal generator 26 operable to generate an ON signal in response to a clock signal, a second control logic 32 operable to control the driver 34 in response to a signal from the ON signal generator 26, and a first control logic 28 operable to control the ON signal generator 26.

An input voltage (VIN) terminal is connected to one terminal of the transistor M1. The LX terminal with the other terminal of the transistor M1 connected thereto is connected the inductor 40 and the diode 46. In the ON state of the transistor M1, an LX terminal voltage VLX turns to a High level, an inductor current IL flows and charges the output capacitor 42, and a current can be supplied to the load 50.

The DC-DC converter shown in FIG. 1 is based on diode rectification. More specifically, while the transistor M1 is turned off, energy accumulated in the inductor 40 is passed through and consumed by the output capacitor 42, the load 50, and the diode 46. The output voltage VO is smoothed near a target voltage by a smoothing circuit 41 composed of the inductor 40 and the output capacitor 42.

The voltage sense resistors 43, 44 connected in series are interposed between the VO terminal and GND. A feedback voltage VFB at a connection node B therebetween is applied to an inverting input terminal of the error amplifier 38 through a VFB terminal.

Here, the output voltage VO can be adjusted to a target voltage value by varying a resistance ratio of RFB1 to RFB2. That is, the output voltage VO can be adjusted by the following formula:

VO=VFB×(1+RFB1/RFB2)

The converter shown in FIG. 1 is a step-down DC-DC converter because VIN>VO.

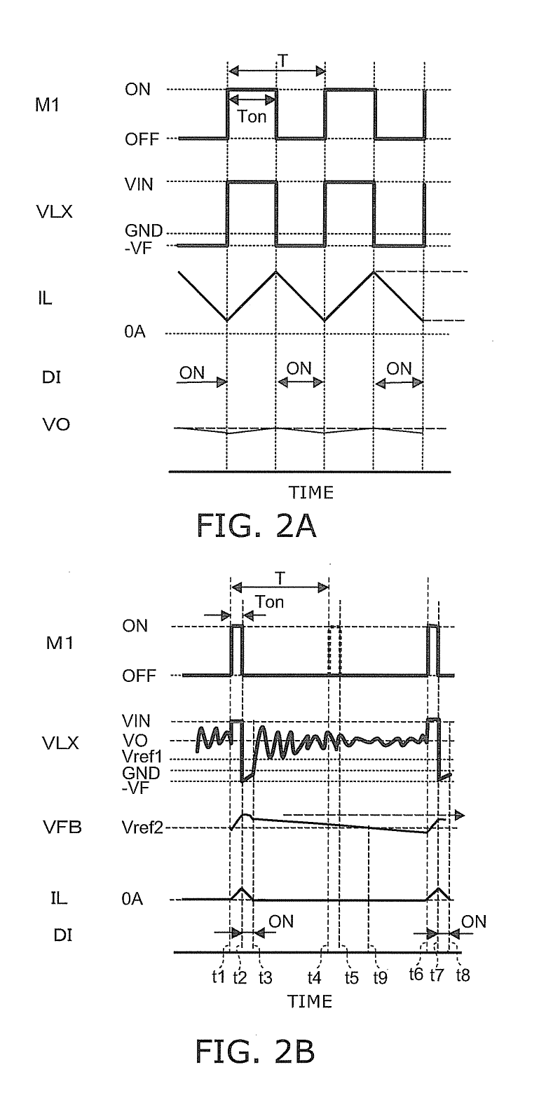

FIGS. 2A and 2B are waveform charts illustrating the operation of the integrated circuit and the DC-DC converter based thereon according to this embodiment. More specifically, FIGS. 2A and 2B show a heavy-load state and light-load state, respectively.

Let f_{OSC} (Hz) denote an oscillation frequency of the oscillator 24. Then, its period T (sec) is given by the following formula:

T=1/f_{OSC}

The oscillation frequency f_{OSC} can be in the range of e.g. 400-800 kHz.

The target output voltage VO can be obtained by causing the driver 34 to vary the duration Ton in which the transistor M1 is turned on.

As shown in FIG. 2A, in the heavy-load case with a high load current, the transistor M1 is turned on by the driver 34 through the second control logic 32 using a high-duty pulse. In the ON state of the transistor M1, the LX terminal voltage VLX is at a High level, which is equal to the input voltage VIN minus a voltage drop due to a slight ON resistance of the transistor M1, and inductor current IL flowing through the inductor 40 increases.

If the control circuit 22 causes the driver 34 to turn off the transistor M1, the LX terminal voltage VLX changes to a voltage near −VF (where VF is the forward voltage of the diode 46) because of a back electromotive force of the inductor 40. Thus, the inductor current IL turns to decreasing, but the direction of the current does not change while the energy accumulated in the inductor 40 remains. The current passed through each of the capacitor 42, the load 50, and the voltage sense resistors 43, 44 can be allowed to flow back through the diode 46.

If the transistor M1 is turned on before the inductor current IL vanishes, then the inductor current IL increases again, and hence does not become discontinuous. Thus, the operation of FIG. 2A can be referred to as the continuous control mode (CCM). Here, if the diode 46 is a silicon pn junction diode, VF is approximately 0.7 V. If it is a silicon Schottky barrier diode, VF is 0.23-0.5 V, which serves to reduce power loss due to forward voltage drop.

In the case of heavy-load operation, the transistor M1 and the diode 46 are controlled so that they are turned on/off complementarily to each other, that is, the diode 46 is turned off in the ON state of the transistor M1, and the diode 46 is turned on in the OFF state of the transistor M1. Because the transistor M1 returns to ON before the inductor current IL reaches zero, no backflow of the inductor current IL occurs. Thus, the output voltage VO can be maintained at a target voltage. Here, typically, the input voltage VIN can be in the range of e.g. 2.7-5.5 V, and the output voltage VO can be e.g. 0.8 V or more.

As shown in FIG. 2B, in the light-load case with a low load current, in response to a signal from the ON signal generator 26, the second control logic 32 turns on the transistor M1 through the driver 34 only for a short ON time Ton. If the transistor M1 turns to ON at time t1, the inductor current IL starts to flow and increases with time.

Subsequently, the transistor M1 turns to OFF at time t2 after a lapse of the short ON time Ton. Hence, the LX terminal voltage VLX becomes generally −VF by the back electromotive force of the inductor 40. The inductor current IL starts to decrease at time t2, and the energy accumulated in the inductor 40 is consumed. Then, at time t3, the inductor current IL generally vanishes. Consequently, the LX terminal voltage VLX becomes generally the GND potential. In this state, the LX terminal has high impedance. However, because the output capacitor 42 is charged, the LX terminal voltage VLX is attenuated with oscillation due to a resonant circuit of the capacitor at the LX terminal and the inductor 40, and goes toward the output voltage VO. Here, the minimum ON time of the ON time Ton can be set to e.g. 60 nsec (nanoseconds).

Furthermore, because the transistor M1 is in the OFF state and the diode 46 is connected in the direction of blocking the backflow current, it is possible to prevent the IC chip 20 and the diode 46 from wastefully consuming power and increase the efficiency in the light-load state. The light-load state of FIG. 2B shows the “discontinuous control mode (DCM)” where the inductor current IL may vanish.

The voltage sensor 36 connected to the LX terminal includes a comparator. The LX terminal voltage VLX and a first reference voltage Vref1 are applied to the first and second input terminal of the comparator, respectively. If the first reference voltage Vref1 is illustratively set in the range of 0.2-0.3 V between GND and the output voltage VO, the voltage sensor 36 detects that the DC-DC converter is operated in the discontinuous operation mode, and applies its output to the first control logic 28.

On the other hand, the output voltage VO is divided by the voltage sense resistors 43, 44 connected in series. The feedback voltage VFB at the connection node B therebetween is applied to the inverting input terminal of the error amplifier 38 through the VFB terminal. Furthermore, a second reference voltage Vref2 is applied to a non-inverting input terminal.

If the LX terminal voltage VLX is higher than the first reference voltage Vref1 and the feedback voltage VFB is higher than the second reference voltage Vref2, then an error signal from the error amplifier 38 is applied to one terminal of the comparator 39. Furthermore, an output of the comparator 39 is applied to the first control logic 28 and controls the Ton signal generator 26 so that the first control logic 28 masks the Ton signal in the period starting at t4. Hence, the second control logic 32 performs control so that the transistor M1 continues to be turned off, and the feedback voltage VFB continues to decrease.

On the other hand, if the LX terminal voltage VLX is higher than the first reference voltage Vref1 and, at time t9, the feedback voltage VFB becomes lower than the second reference voltage Vref2, then the error amplifier 38 outputs a forced ON signal to the comparator 39. Hence, in response to receiving the output of the comparator 39, the first control logic 28 causes the Ton generator 26 to generate a Ton signal in the period starting at t6. Furthermore, the first logic 28 turns on the transistor M1 through the second control logic 32 and the driver 34. Thus, the feedback voltage VFB is maintained stably near the second reference voltage Vref2, and the output voltage VO can be accurately kept at the target voltage value.

Furthermore, a series circuit of a resistor 31 and a transistor M2 having the same conductivity type as the transistor M1 is connected in parallel to the transistor M1. A current sense amplifier 30 detects whether the transistor M1 is turned on or off using the voltage across this resistor 31, and its output is applied to the other terminal of the comparator 39.

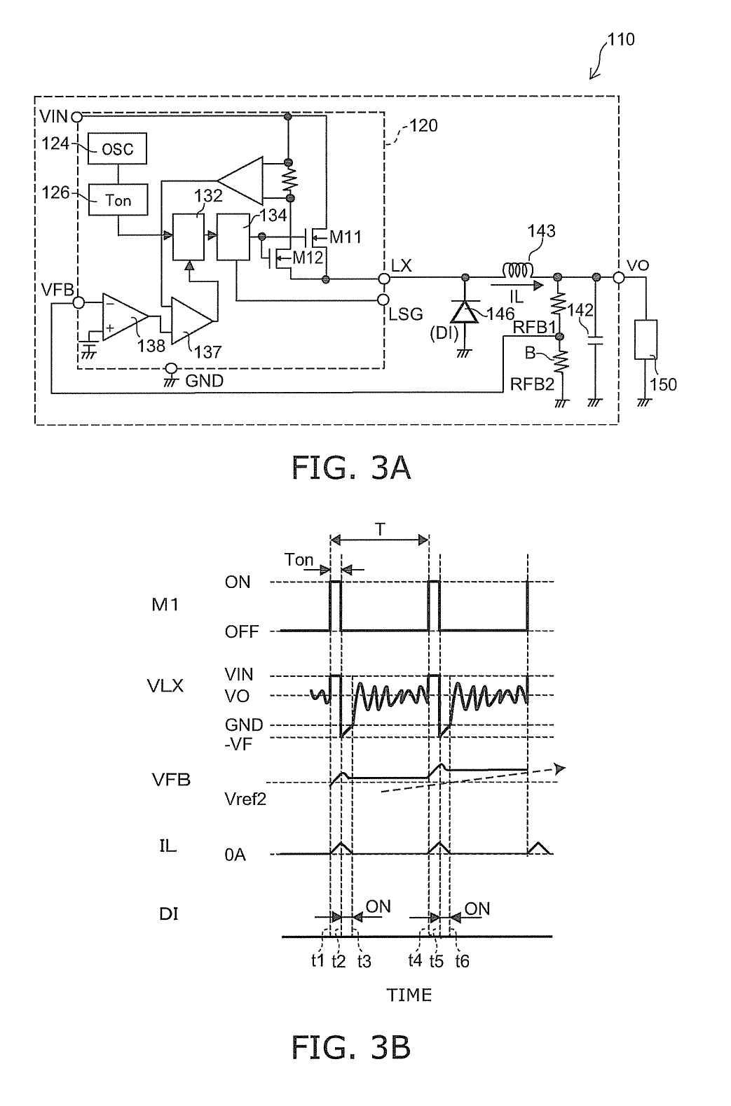

FIG. 3A is a block diagram of a DC-DC converter according to a comparative example, and FIG. 3B is an operating waveform chart in the light-load state. As shown in FIG. 3A, this comparative example includes no LX terminal voltage sensor and first control logic, and an output of a Ton generator 126 and an output of a comparator 137 are applied to a second control logic 132.

In the comparative example, the Ton generator 126 generates a Ton signal every period, and the second control logic 132 turns on a transistor M11 through a driver 134 every period. When the transistor M11 turns to OFF at t2, an LX terminal voltage VLX once decreases to −VF by a back electromotive force of an inductor 140. Furthermore, the LX terminal voltage VLX varies with the decrease of the inductor current IL. When accumulated energy is consumed at time t3, the inductor current IL vanishes. A diode 146 is ON only from t2 to t3.

After time t3, the LX terminal voltage VLX goes toward an output voltage VO with oscillation due to the inductance of the inductor 140 and the capacitor at the LX terminal. However, in the comparative example, because no voltage sensor is connected to an LX terminal, the LX terminal voltage VLX cannot be detected. A charge in an output capacitor 142 charged during t1-t3 is maintained because there is no backflow path. Subsequently, at time t4, when the transistor M11 is again turned on by the Ton signal, the output capacitor 142 is further charged, thereby increasing the output voltage VO and a feedback voltage VFB. In the light-load state beyond the range controllable in the minimum ON time, a system becomes difficult to control, causing a problem of the increase of the feedback voltage VFB and the output voltage VO.

In contrast, this embodiment detects the LX terminal voltage VLX to disable the ON signal for the next period in the operating state of the light-load discontinuous control mode, thereby providing a period during which the transistor M1 is not turned on. Hence, also at light load, the increase of the output voltage VO is prevented, and variation in the output voltage VO is limited to ±2% or less. Thus, the operation can be stabilized.

Here, the voltage sensor 36 at the LX terminal does not require high accuracy and high speed, but may be implemented by addition of a simple circuit. Furthermore, the first reference voltage Vref1, which is set in a voltage range between the output voltage VO and GND, does not require high accuracy. Hence, addition of the voltage sensor 36 does not complicate a configuration of the IC chip 20.

Furthermore, the backflow current is prevented by the diode 46, which facilitates increasing the conversion efficiency even at light load. This facilitates downsizing electronic devices such as notebook personal computers and cellular phones, and reducing their power consumption.

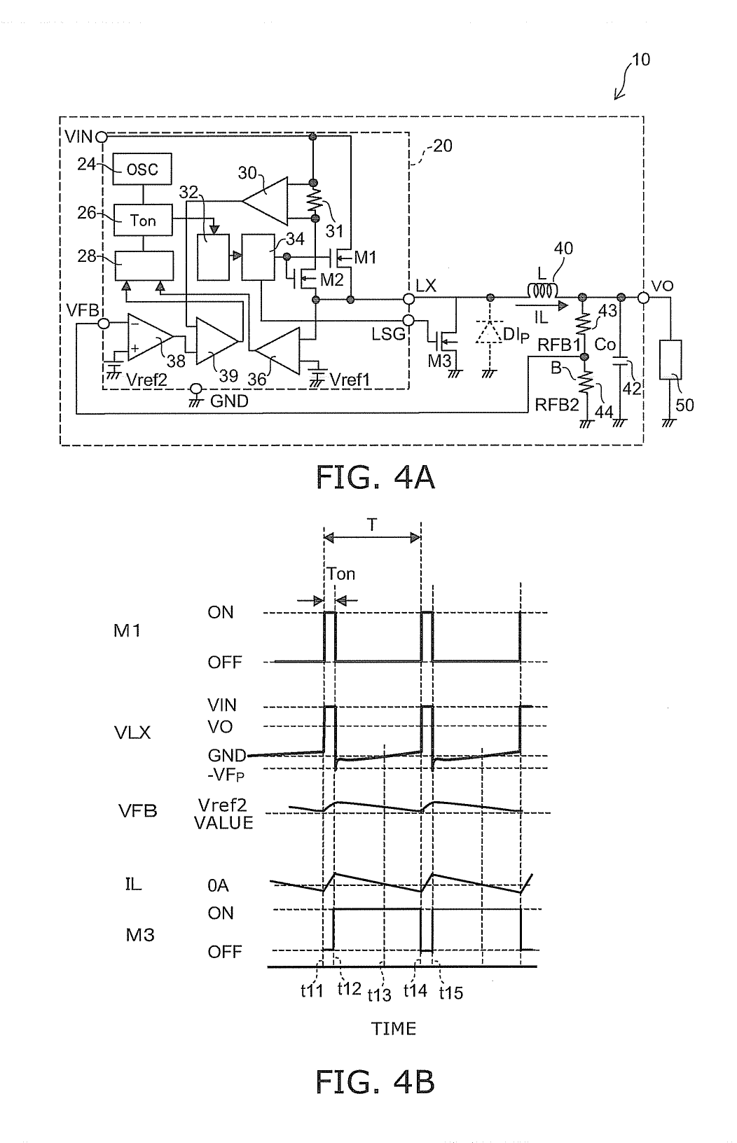

FIG. 4A is a block diagram of a DC-DC converter according to a second embodiment, and FIG. 4B is an operating waveform chart in the light-load state.

A low-side switch control terminal LSG provided in the integrated circuit 20 allows an external low-side transistor M3 (hereinafter referred to as transistor M3) to be turned on or off by the driver 34, realizing operation as a synchronous rectification DC-DC converter.

The LSG terminal is connected to a gate of a transistor M3 illustratively made of an N-channel MOSFET, and can control the transistor M3 through the driver 34. Furthermore, it can be assumed that a parasitic diode DI_{P} indicated by the dashed line is connected in parallel to the transistor M3.

At time t12, the transistor M1 turns from ON to OFF, whereas the transistor M3 complementarily turns from OFF to ON. The LX terminal voltage VLX once decreases to −VF_{P} (where VF_{P} is the forward voltage of the parasitic diode DI_{P}) at time t12, but returns to GND when the inductor current IL vanishes at time t13. Because the transistor M3 is ON, charge accumulated in the output capacitor starts backflow through the transistor M3 at time 13.

At time t14, when the transistor M1 again turns to ON, the inductor current IL increases again during t14-t15. During t13-t14, the LX terminal voltage VLX is slightly higher than GND, such as 0-0.1 V, but the inductor current IL can flow back through the transistor M3, and hence does not increase close to the output voltage VO with oscillation as in the embodiment shown in FIG. 2.

In this case, if the first reference voltage Vref1 is illustratively set in the range of 0.2-0.3 V, the voltage sensor 36 can detect that VLX<Vref1. Hence, the first control logic 28 can control the Ton generator 26 so as to generate a Ton signal every period, thereby turning on the transistor M1 every period. That is, in the operating state of the continuous control mode, a synchronous rectification DC-DC converter can be easily controlled.

A voltage drop of the MOSFET or other switching transistor is smaller than the forward voltage VF of the diode. Hence, in the heavy-load state, the efficiency of the synchronous rectification converter can be easily made higher than the efficiency of the diode rectification converter.

Thus, use of the integrated circuit 20 of the present embodiments to implement the diode rectification and synchronous rectification DC-DC converter allows commonality of components in the chip of the integrated circuit 20, which reduces the number of major components and facilitates process control.

The embodiments of the invention have been described with reference to the drawings. However, the invention is not limited to these embodiments. For example, those skilled in the art can suitably modify the layout, size, shape, material and the like of the transistor, the driver thereof, LX terminal voltage sensor, control circuit, inductor, capacitor, smoothing circuit, resistor, and rectifying element constituting the DC-DC converter, and such modifications are also encompassed within the scope of the invention as long as they do not depart from the spirit of the invention.

1. A DC-DC converter integrated circuit comprising:
a switching terminal;
a feedback terminal;
a high-side transistor operable to output a voltage through the switching terminal in ON state;
a voltage sensor operable to compare voltage at the switching terminal with a first reference voltage;
an error amplifier operable to generate an error signal from voltage at the feedback terminal and a second reference voltage; and
a control circuit, on detecting the voltage at the switching terminal higher than the first reference voltage in OFF state of the high-side transistor using the voltage sensor, operable to make the high-side transistor turn off in a next period after detecting the voltage at the feedback terminal higher than the second reference voltage using the error signal, and turn on in a next period after detecting the voltage at the feedback terminal lower than the second reference voltage using the error signal.

2. The integrated circuit according to claim 1, wherein the control circuit is operable to make the high-side transistor turn on every period, on detecting the voltage at the switching terminal lower than the first reference voltage in the OFF state of the high-side transistor using the voltage sensor.

3. The integrated circuit according to claim 1, wherein the control circuit includes:
an oscillator operable to generate a clock signal;
an ON signal generator operable to generate an ON signal in response to the clock signal; and
a driver circuit operable to drive the high-side transistor in response to the ON signal.

4. The integrated circuit according to claim 1, further comprising:
a series-connected circuit including a transistor having the same conductivity type as the high-side transistor and a resistor, the series-connected circuit being connected in parallel to the high-side transistor,
voltage across the resistor being operable to detect whether the high-side transistor is turned on or off.

5. The integrated circuit according to claim 2, wherein the control circuit is operable to output a control signal through a low-side switch control terminal to turn on or off an external low-side transistor.

6. A DC-DC converter comprising:
a DC-DC converter integrated circuit including:
a switching terminal;
a feedback terminal;
a high-side transistor operable to output a voltage through the switching terminal in ON state; and
a control circuit in a case of the voltage at the switching terminal higher than a first reference voltage in OFF state of the high-side transistor, operable to make the high-side transistor turn off in a next period after detecting the voltage at the feedback terminal higher than a second reference voltage, and turn on in a next period after detecting the voltage at the feedback terminal lower than the second reference voltage;
an output terminal;
an inductor interposed between the switching terminal and the output terminal;
a diode interposed between the switching terminal and ground; and
voltage sense resistors interposed between the output terminal and the ground and connected in series so as to allow voltage at the connection node therebetween to be fed back to the feedback terminal.

7. The converter according to claim 6, wherein the control circuit includes:
an oscillator operable to generate a clock signal;
an ON signal generator operable to generate an ON signal in response to the clock signal; and
a driver circuit operable to drive the high-side transistor in response to the ON signal.

8. The converter according to claim 6, further comprising:
a capacitor interposed between the output terminal and the ground and constituting a smoothing circuit in conjunction with the inductor.

9. The converter according to claim 6, wherein the control circuit is operable to make the high-side transistor turn on every period, on detecting the voltage at the switching terminal lower than the first reference voltage in the OFF state of the high-side transistor.

10. The converter according to claim 6, wherein voltage at the output terminal is lower than the voltage at the switching terminal in the ON state of the high-side transistor.

11. The converter according to claim 10, wherein the first reference voltage is set between the voltage at the output terminal and the ground.

12. A DC-DC converter comprising:
a DC-DC converter integrated circuit including:
a switching terminal;
a feedback terminal;
a low-side switch control terminal;
a high-side transistor operable to output a voltage through the switching terminal in ON state; and
a control circuits on detecting the voltage at the switching terminal lower than the first reference voltage in the OFF state of the high-side transistor, operable to make the high-side transistor turn on every period and output a control signal to the low-side switch control terminal;
an output terminal;
a low-side transistor connected between the switching terminal and ground and allowed to be turned on or off complementarily to the high-side transistor by the control signal from the low-side switch control terminal;
an inductor interposed between the switching terminal and the output terminal; and
voltage sense resistors interposed between the output terminal and the ground and connected in series so as to allow voltage at the connection node therebetween to be fed back to the feedback terminal.

13. The converter according to claim 12, further comprising:
a capacitor interposed between the output terminal and the ground and constituting a smoothing circuit in conjunction with the inductor.

14. The converter according to claim 12, wherein voltage at the output terminal is lower than the voltage at the switching terminal in the ON state of the high-side transistor.

15. The converter according to claim 14, wherein the first reference voltage is set between the voltage at the output terminal and the ground.
